(19) United States
(12) Patent Application Publication
(10) Pub. No.: US 2012/0167194 A1
(43) Pub. Date: Jun. 28, 2012

(54) CLIENT HARDWARE AUTHENTICATED TRANSACTIONS

(76) Inventors: KENNETH W. REESE, Portland, OR (US); RAVIPRAKASH NAGARAJ, Tigard, OR (US); SANJAY BAKSHI, Portland, OR (US); AMOL A. KULKARNI, Hillsboro, OR (US); RANJIT S. NARJALA, Portland, OR (US)

(21) Appl. No.: 12/976,486

(22) Filed: Dec. 22, 2010

(51) Int. Cl. H04L 9/32; G06F 21/00

(52) U.S. Cl. 726/9

(57) ABSTRACT

In one embodiment a controller comprises logic to receive a request for a credential to authenticate a user for a transaction, in response to a determination that a credential which satisfies the request resides on a memory module, execute an authentication routine to authenticate a user of the controller, in response to a successful authentication, retrieve the credential from the memory module, and provide a token to certify the credential in response to the request. Other embodiments may be described.

### RELATED APPLICATIONS

None.

### BACKGROUND

The subject matter described herein relates generally to the field of electronic devices and more particularly to a system and method to implement client hardware authenticated transactions using electronic devices.

In a typical electronic commerce transaction the merchant (and underlying ecosystem), is not certain that the individual conducting the transaction is the authorized person. When fraudulent transactions are accepted by the online ecosystem there is an underlying fraud cost that is generally borne by the relying party, in this example the merchant, or by the defrauded individual.

Another weakness in the online space is the ever-present threat of system malware, which is often used to steal personal information, including payment credentials, for use by unauthorized individuals. This threat has an effect on a certain percentage of the population who will not conduct online activity due to fear of having their information compromised. This reduces efficiencies that can be gained through online commerce and limits the amount of goods and services purchased by concerned individuals, limiting the growth of online commerce.

Existing solutions to these problems are limited in their usefulness and/or security due to the fact that they are hosted inside the PC operating system, which is always a point of vulnerability, or require external, attached hardware devices, which limit consumer ease-of-use factors. Accordingly systems and techniques to provide a secure computing environment for electronic commerce may find utility.

### BRIEF DESCRIPTION OF THE DRAWINGS

The detailed description is described with reference to the accompanying figures.

FIG. 1 is a schematic illustration of an exemplary electronic device which may be adapted to include infrastructure for client hardware authenticated transactions accordance with some embodiments.

FIG. 2 is a high-level schematic illustration of an exemplary architecture for client hardware authenticated transactions accordance with some embodiments.

FIG. 3 is a schematic illustration of an exemplary architecture for client hardware authenticated transactions accordance with some embodiments.

FIG. 4 is a flowchart illustrating operations in a method to implement client hardware authenticated transactions accordance with some embodiments.

FIG. 5 is a schematic illustration of an electronic device which may be adapted to implement client hardware authenticated transactions accordance with some embodiments.

### DETAILED DESCRIPTION

Described herein are exemplary systems and methods to implement a client hardware authenticated transactions (CHAT) in electronic devices. In the following description, numerous specific details are set forth to provide a thorough understanding of various embodiments. However, it will be understood by those skilled in the art that the various embodiments may be practiced without the specific details. In other instances, well-known methods, procedures, components, and circuits have not been illustrated or described in detail so as not to obscure the particular embodiments.

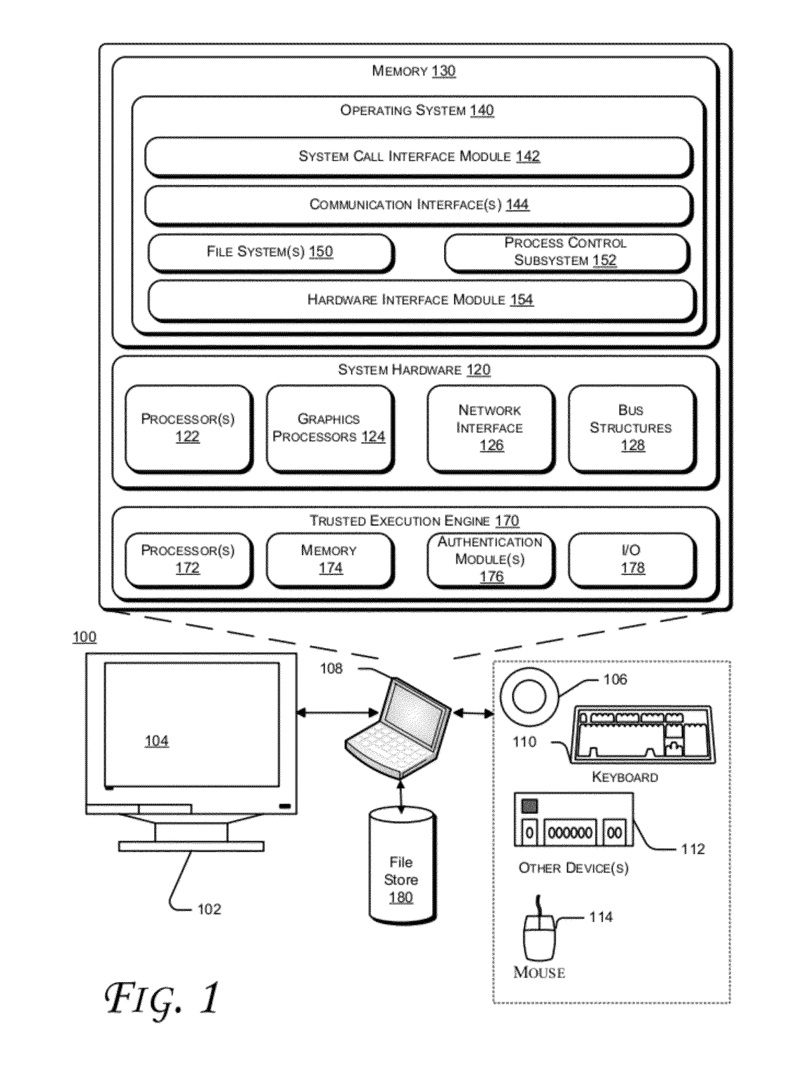

FIG. 1 is a schematic illustration of an exemplary system 100 which may be adapted to implement client hardware authenticated transactions in accordance with some embodiments. In one embodiment, system 100 includes an electronic device 108 and one or more accompanying input/output devices including a display 102 having a screen 104, one or more speakers 106, a keyboard 110, one or more other I/O device(s) 112, and a mouse 114. The other I/O device(s) 112 may include a touch screen, a voice-activated input device, a track ball, a geolocation device, an accelerometer/gyroscope, biometric feature input devices, and any other device that allows the system 100 to receive input from a user.

In various embodiments, the electronic device 108 may be embodied as a personal computer, a laptop computer, a personal digital assistant, a mobile telephone, an entertainment device, or another computing device. The electronic device 108 includes system hardware 120 and memory 130, which may be implemented as random access memory and/or read-only memory. A file store 180 may be communicatively coupled to computing device 108. File store 180 may be internal to computing device 108 such as, e.g., one or more hard drives, CD-ROM drives, DVD-ROM drives, or other types of storage devices. File store 180 may also be external to computer 108 such as, e.g., one or more external hard drives, network attached storage, or a separate storage network.

System hardware 120 may include one or more processors 122, graphics processors 124, network interfaces 126, and bus structures 128. In one embodiment, processor 122 may be embodied as an Intel® Core2 Duo® processor available from Intel Corporation, Santa Clara, Calif., USA. As used herein, the term “processor” means any type of computational element, such as but not limited to, a microprocessor, a microcontroller, a complex instruction set computing (CISC) microprocessor, a reduced instruction set (RISC) microprocessor, a very long instruction word (VLIW) microprocessor, or any other type of processor or processing circuit.

Graphics processor(s) 124 may function as adjunct processor that manages graphics and/or video operations. Graphics processor(s) 124 may be integrated onto the motherboard of computing system 100 or may be coupled via an expansion slot on the motherboard.

In one embodiment, network interface 126 could be a wired interface such as an Ethernet interface (see, e.g., Institute of Electrical and Electronics Engineers/IEEE 802.3-2002) or a wireless interface such as an IEEE 802.11a, b or g-compliant interface (see, e.g., IEEE Standard for IT-Telecommunications and information exchange between systems LAN/MAN—Part II: Wireless LAN Medium Access Control (MAC) and Physical Layer (PHY) specifications Amendment 4: Further Higher Data Rate Extension in the 2.4 GHz Band, 802.11G-2003). Another example of a wireless interface would be a general packet radio service (GPRS) interface (see, e.g., Guidelines on GPRS Handset Requirements, Global System for Mobile Communications/GSM Association, Ver. 3.0.1, December 2002).

Bus structures 128 connect various components of system hardware 128. In one embodiment, bus structures 128 may be one or more of several types of bus structure(s) including a memory bus, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

Memory 130 may include an operating system 140 for managing operations of computing device 108. In one embodiment, operating system 140 includes a hardware interface module 154 that provides an interface to system hardware 120. In addition, operating system 140 may include a file system 150 that manages files used in the operation of computing device 108 and a process control subsystem 152 that manages processes executing on computing device 108.

Operating system 140 may include (or manage) one or more communication interfaces that may operate in conjunction with system hardware 120 to transceive data packets and/or data streams from a remote source. Operating system 140 may further include a system call interface module 142 that provides an interface between the operating system 140 and one or more application modules resident in memory 130. Operating system 140 may be embodied as a UNIX operating system or any derivative thereof (e.g., Linux, Solaris, etc.) or as a Windows® brand operating system, or other operating systems.

In some embodiments system 100 may comprise a low-power embedded processor, referred to herein as a trusted execution engine 170. The trusted execution engine 170 may be implemented as an independent integrated circuit located on the motherboard of the system 100. In the embodiment depicted in FIG. 1 the trusted execution engine 170 comprises a processor 172, a memory module 174, an authentication module 176, and an I/O module 178. In some embodiments the memory module 164 may comprise a persistent flash memory module and the authentication module 174 may be implemented as logic instructions encoded in the persistent memory module, e.g., firmware or software. The I/O module 178 may comprise a serial I/O module or a parallel I/O module. Because the trusted execution engine 170 is physically separate from the main processor(s) 122 and operating system 140, the trusted execution engine 170 may be made secure, i.e., inaccessible to hackers such that it cannot be tampered with.

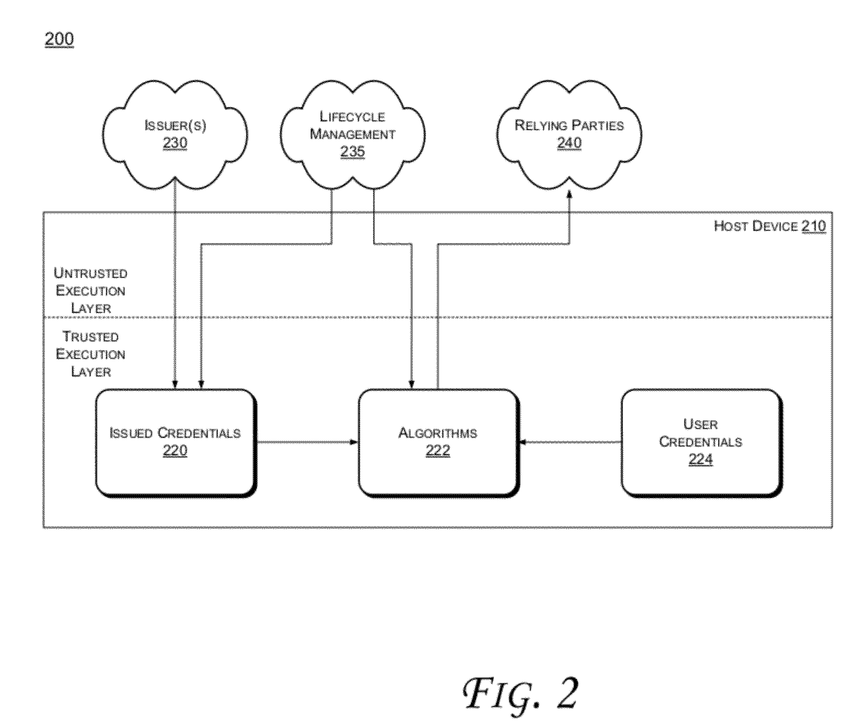

In some embodiments the trusted execution engine may be used to define a trusted domain in a host electronic device in which authentication procedures may be implemented. FIG. 2 is a high-level schematic illustration of an exemplary architecture for client hardware authenticated transactions accordance with some embodiments. Referring to FIG. 2, a host device 210 may be characterized as having an untrusted domain and a trusted domain. When the host device 210 is embodied as a system 100 the trusted domain may be implemented by the trusted execution engine 170, while the untrusted domain may be implemented by the main processors(s) 122 and operating system 140 of the system 100. As illustrated in FIG. 2, remote entities that issue credentials, identified as issuers 230 in FIG. 2, supply credentials, which are stored in the trusted domain of the host device 210. In use, the issued credentials and one or more user credentials 224 may be provided as inputs to one or more authentication algorithms 222, which process the credentials and generate a token, which may be provided to one or more relying parties 240. Integrity of the trusted domain may be maintained through exclusive, cryptographically-protected, relationships between a trusted domain and entities that are allowed to issue credentials into 220 or lifecycle manage 235 the contents and algorithms 222 of the trusted domain.

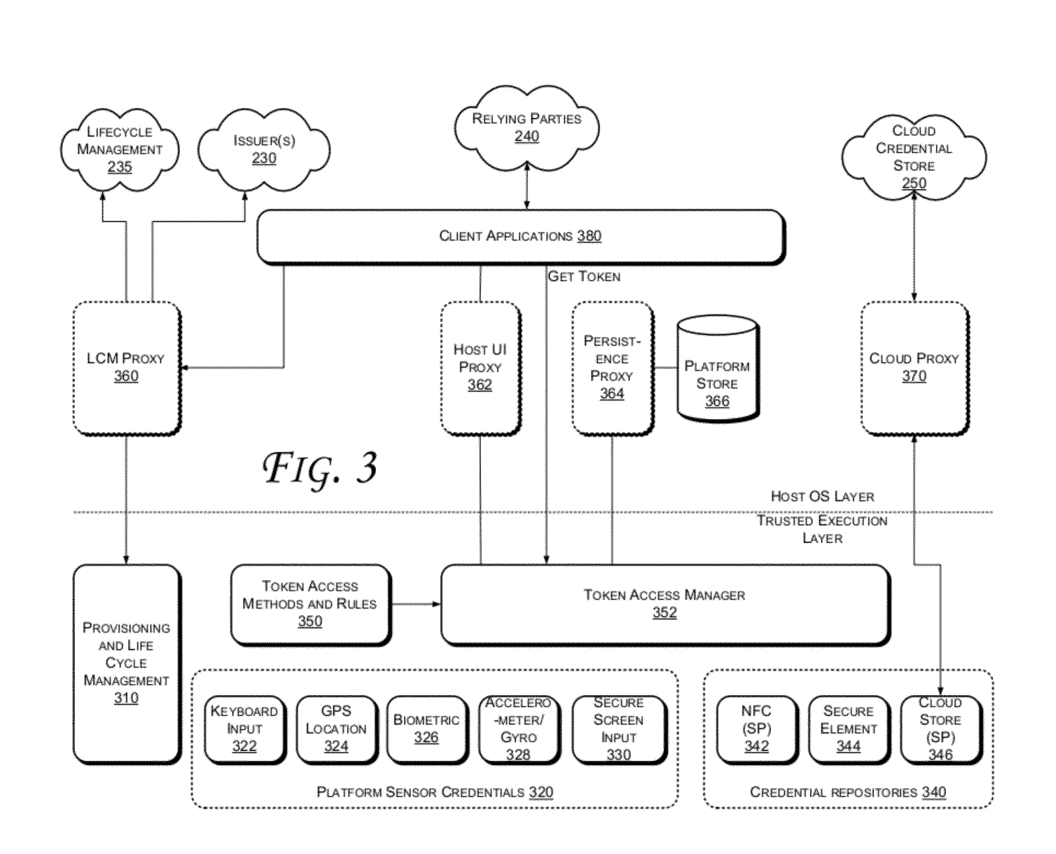

FIG. 3 is a schematic illustration in greater detail of an exemplary architecture for client hardware authenticated transactions accordance with some embodiments. In the embodiment depicted in FIG. 3, the trusted execution layer comprises a provisioning and life cycle management module 310, a platform sensor credentials module 320, and a set of credential repositories 340. A token access manager module 352 accepts as inputs one or more token access methods and rules 350 stored in the trusted execution layer.

In the embodiment depicted in FIG. 3 the platform sensor credential may comprise one or more of a secured keyboard input path credential 322, a GPS location credential, a biometric credential 326, an accelerometer or gyroscope credential 328, or a malware-interception-resistant secure screen input mechanism credential 330. The credential repositories 340 may comprise a NFC input device 342, one or more secure elements 344, and a cloud credential store access mechanism 346.

The untrusted execution layer (i.e., the Host Operating System layer) implements a series of proxies to facilitate communication with the trusted execution layer components. Thus, the untrusted execution layer maintains a life cycle management proxy 360 to facilitate communicate between the provisioning and life cycle management module 310 and remote issuers 230 of credentials, and entities delegated to securely manage 235 the trusted execution layer. Similarly, a host proxy 362 facilitates communication between one or more client applications 380 which execute in the untrusted execution layer and the token access manager 352. A persistence proxy 364 provides a communication link between the token access manager 352 and a platform data store 366. A cloud proxy 370 provides a communication link between cloud credential stores 250 and the cloud store access mechanism 346.

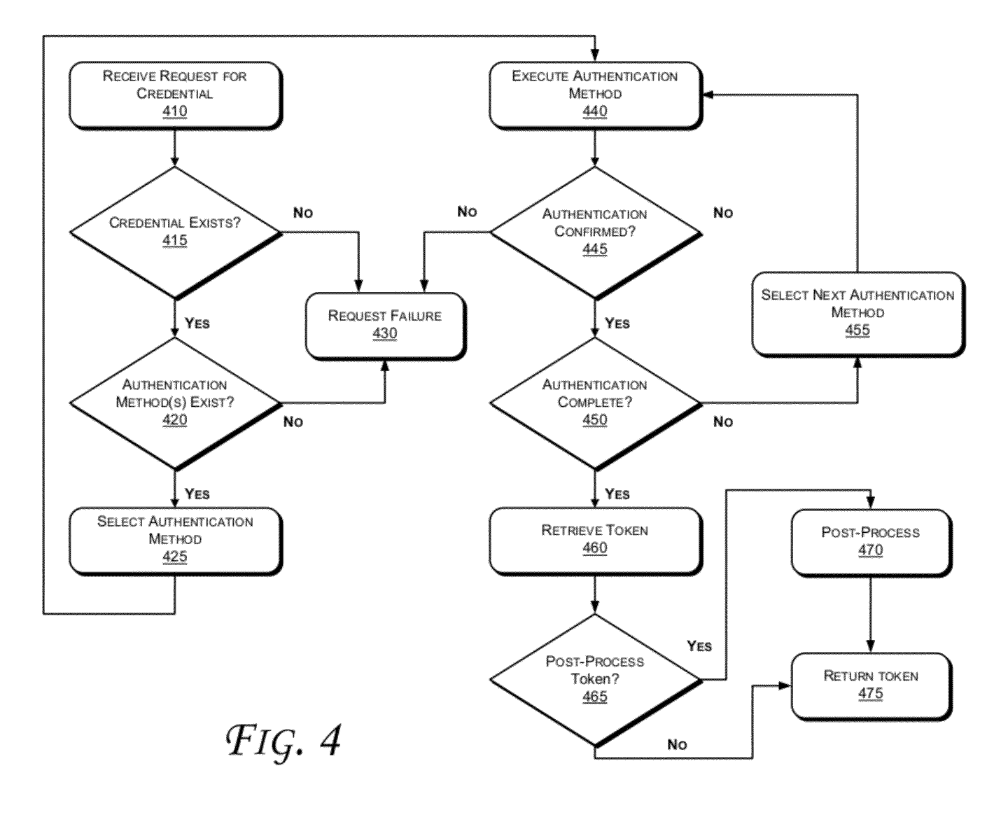

Having described various structures of a system for client hardware authenticated transactions, operating aspects of a system will be explained with reference to FIG. 4, which is a flowchart illustrating operations in a method to implement client hardware authenticated transactions accordance with some embodiments. In some embodiments the operations depicted in the flowchart of FIG. 4 may be implemented by the authentication module(s) 176 of the trusted execution engine 170.

In use, the system my obtain credentials from a variety of sources. For example, issuers 230 may issue credentials to the system via the LCM proxy 360. Issued credentials may include dynamic cryptogram (OTP) generation seeds, user certificates (e.g., x509 certificates with public/private key pairs), financial information (e.g., credit card information), bank card information, or the like. Issued credentials may be stored in one or more of the credential repositories 340. By contrast, the platform sensor credentials 320 may be obtained from the user in response to requests from a relying party, either in real time during an authentication process or in advance. One skilled in the art will recognize that platform sensor credentials may be requested indirectly as the result of the relying party asking for other credential, as described below, or even directly by a relying party. By way of example, biometric signatures may be cataloged for users, allowing a centrally-run authentication verification system. Using embodiments described herein, a relying party could ask the platform for a fingerprint credential. The platform would obtain this credential using its fingerprint acquisition hardware, and would return this information to the requesting/relying party.

Referring to FIG. 4, at operation 410 a system receives a request for one or more credentials. By way of example, the request may be initiated by a remote entity such as an online shopping entity or a banking entity. At operation 415 it is determined whether a credential corresponding to the requested credential exists. By way of example, the credential repositories 340 may be searched for one or more credentials corresponding to the requested credential(s).

If, at operation 415, the requested credential(s) do not exist then control passes to operation 430 and the request is deemed a failure. In this circumstance a failure indictor may be presented on a user interface of the system 100. By way of example a failure message may be presented on the display 104 of the device or an audible failure indicator may be presented on the speaker 106.

By contrast, if at operation 415 the requested credential(s) exist then control passes to operation 420, where it is determined whether authentication methods exists. If no authentication methods exist for the requested credential(s) then again control passes to operation 430 and the request is deemed a failure and a failure indicator may be presented. However, if at operation 420 one or more authentication methods exist for the requested credential the control passes to operation 425 and an authentication method is selected, and at operation 440 the selected authentication method is executed.

The particular authentication method(s) may be established by the token access methods and rules module 350. By way of example, the user may be asked to enter a particular character string on a keyboard, which may be intercepted by a trusted keyboard input system 322. Alternatively, a geolocation system such as the global positioning system (GPS) may be used to establish a GPS location credential 324 (i.e., where the device is located). A biometric sensor such as a fingerprint scanner may be used to establish a biometric credential 326. An accelerometer and/or gyroscope may be used to establish a motion-based credential. For example, a user may be requested to rotate the system 100 in a particular orientation.

If, at operation 445, the authentication method is unsuccessful and authentication cannot be confirmed, then again control passes to operation 430 and the request is deemed a failure and a failure indicator may be presented. By contrast if authentication is confirmed then control passes to operation 450, where it is determined whether the authentication process is complete. Authentication methods may be combined to provide a stronger, multi-factor authentication. In such cases some credentials may require multiple levels of authentication. If further authentication is required then control passes to operation 455 where the next authentication method is selected, and to operation 440, where the authentication method is executed. Operations 440-455 thus form a loop pursuant to which multiple authentication methods may be required.

If, at operation 450, the authentication process completes successfully then control passes to operation 460 and a token is retuned from the token access manager 352. The token may be returned in response to the request for the credential received in operation 410. In some circumstances the retrieved token may not be sufficient to satisfy a credential request 410. In such cases one or more post-processing operations provide for processing to complete a credential request 410. By way of example, a digital signature algorithm may be applied to a returned financial token. The digital signature would assert to the relying party that the token was being returned by the consent of a specific individual or computer platform. The relying party 420 may use the token to determine whether to grant the user of the system 100 access to a resource such as a banking transaction or a commercial exchange transaction.

Thus, if at operation 465, a post-processing operation is useful for the token, then control passes to operation 470 and a post processing algorithm is implemented. By way of example, in the case of a one-time-password, the retrieved credential at 460 may be a static, cryptographic secret that is known only to the CHAT system and the person who issued the secret. To turn the secret into a one-time-password requires that the seed be combined with other information (e.g., a random number and a counter), and then run through some post-processing algorithm such as a SHA-1 hash generator. The result of this post-processing is a one-time-password that is returned to the relying party at operation 475.

In other embodiments the token retrieved in 460 may be a credit card number which may be accompanied by a digital signature attesting to a user confirmation (i.e., digital signature algorithms involve cryptographic operations executed using a secret, private key owned by the user). The operation that generates the digital signature and appends it to the credit card at operation 470. At this point the composite ‘token’ can be returned to the relying party at operation 475.

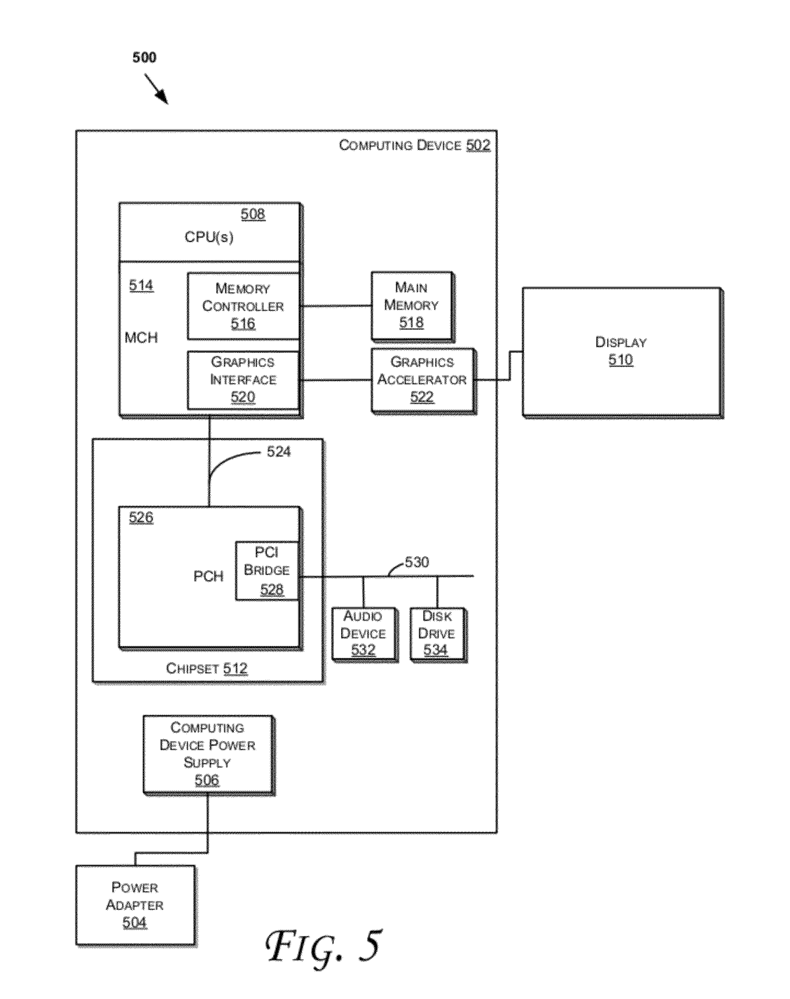

As described above, in some embodiments the electronic device may be embodied as a computer system. FIG. 5 is a schematic illustration of a computer system 500 in accordance with some embodiments. The computer system 500 includes a computing device 502 and a power adapter 504 (e.g., to supply electrical power to the computing device 502). The computing device 502 may be any suitable computing device such as a laptop (or notebook) computer, a personal digital assistant, a smart phone, a desktop computing device (e.g., a workstation or a desktop computer), a rack-mounted computing device, and the like.

Electrical power may be provided to various components of the computing device 502 (e.g., through a computing device power supply 506) from one or more of the following sources: one or more battery packs, an alternating current (AC) outlet (e.g., through a transformer and/or adaptor such as a power adapter 504), automotive power supplies, airplane power supplies, and the like. In some embodiments, the power adapter 504 may transform the power supply source output (e.g., the AC outlet voltage of about 110 VAC to 240 VAC) to a direct current (DC) voltage ranging between about 7 VDC to 12.6 VDC. Accordingly, the power adapter 504 may be an AC/DC adapter.

The computing device 502 may also include one or more central processing unit(s) (CPUs) 508. In some embodiments, the CPU 508 may be one or more processors in the Pentium® family of processors including the Pentium® II processor family, Pentium® III processors, Pentium® IV , CORE2 Duo processors, or Atom processors available from Intel® Corporation of Santa Clara, Calif. Alternatively, other CPUs may be used, such as Intel's Itanium®, XEON™, and Celeron® processors. Also, one or more processors from other manufactures may be utilized. Moreover, the processors may have a single or multi core design.

A chipset 512 may be coupled to, or integrated with, CPU 508. The chipset 512 may include a memory control hub (MCH) 514. The MCH 514 may include a memory controller 516 that is coupled to a main system memory 518. The main system memory 518 stores data and sequences of instructions that are executed by the CPU 508, or any other device included in the system 500. In some embodiments, the main system memory 518 includes random access memory (RAM); however, the main system memory 518 may be implemented using other memory types such as dynamic RAM (DRAM), synchronous DRAM (SDRAM), and the like. Additional devices may also be coupled to the bus 510, such as multiple CPUs and/or multiple system memories.

The MCH 514 may also include a graphics interface 520 coupled to a graphics accelerator 522. In some embodiments, the graphics interface 520 is coupled to the graphics accelerator 522 via an accelerated graphics port (AGP). In some embodiments, a display (such as a flat panel display) 540 may be coupled to the graphics interface 520 through, for example, a signal converter that translates a digital representation of an image stored in a storage device such as video memory or system memory into display signals that are interpreted and displayed by the display. The display 540 signals produced by the display device may pass through various control devices before being interpreted by and subsequently displayed on the display.

A hub interface 524 couples the MCH 514 to an platform control hub (PCH) 526. The PCH 526 provides an interface to input/output (I/O) devices coupled to the computer system 500. The PCH 526 may be coupled to a peripheral component interconnect (PCI) bus. Hence, the PCH 526 includes a PCI bridge 528 that provides an interface to a PCI bus 530. The PCI bridge 528 provides a data path between the CPU 508 and peripheral devices. Additionally, other types of I/O interconnect topologies may be utilized such as the PCI Express™ architecture, available through Intel® Corporation of Santa Clara, Calif.

The PCI bus 530 may be coupled to an audio device 532 and one or more disk drive(s) 534. Other devices may be coupled to the PCI bus 530. In addition, the CPU 508 and the MCH 514 may be combined to form a single chip. Furthermore, the graphics accelerator 522 may be included within the MCH 514 in other embodiments.

Additionally, other peripherals coupled to the PCH 526 may include, in various embodiments, integrated drive electronics (IDE) or small computer system interface (SCSI) hard drive(s), universal serial bus (USB) port(s), a keyboard, a mouse, parallel port(s), serial port(s), floppy disk drive(s), digital output support (e.g., digital video interface (DVI)), and the like. Hence, the computing device 502 may include volatile and/or nonvolatile memory.

Thus, there is described herein an architecture and associated methods to implement client hardware authenticated transactions in electronic devices. In some embodiments the architecture uses hardware capabilities embedded in an electronic device platform to provide assurances to transaction-authorizing parties that a transaction is being made by an authorized individual. In the embodiments described herein authentication and persistence are based processing that occurs within a trusted environment, separate from the host operating system. The execution environment may be implemented in a trusted execution engine, which obtains and verifies user identity, then provides proof of identity verification, and may provide other elements required to satisfy transaction requirements. The result is a platform-issued token that represents fulfillment of these required elements to relying parties. In some embodiments the trusted execution engine may be implemented in a remote or attachable device, e.g., a dongle,

The architecture utilizes on hardware-based capabilities to acquire user authentication credentials to provide assurances that the credentials are being provided by authorizing individuals. These credentials take on the form of accepted authentication factors. Example factors include protected inputs (i.e., what you know), biometric inputs (i.e., who you are), one-time passwords (i.e., what you have), location information (i.e., where you are), and accelerometer/gyroscope information (i.e., what you do). The hardware has secure capabilities to store and/or acquire issued credentials granted by appropriate authorities, which serve to provide required information to relying parties. Examples of issued credentials include (but are not limited to dynamic cryptogram (OTP) generation seeds, user certificates (e.g. x509 with public/private key pair), financial information (e.g. credit card information), and bank cards (not stored on platform, but information acquired via secure hardware such as 342).

The algorithms and rules managed by the token access method and rules module 350 executing in the trusted execution layer pairs of these classes of credentials and factors (and resulting tokens). Because the algorithms executed in a trusted execution layer the opportunity for malware to insert itself in spoofing or man-in-the-browser authentication attacks is virtually eliminated. Where direct linkage is not possible the linkage between systems is provided using cryptographic techniques (e.g. using functions inherent in 352, 364 and 366), effectively neutralizing threats due to data interception and replay.

The architecture also enables multi-factor authentication factors via factor serialization. Again, because these compounding processes execute in a trusted environment they too are protected from malware or tampering.

In one embodiment the trusted execution engine 170 displays a randomized numeric pad and then uses the guest operating system 140 and secure screen input 330 to acquire mouse clicks that represent digits that correspond to an assigned credential passcode. Upon verification of the passcode the trusted execution engine 170 generates a dynamic cryptogram that asserts to a relying party 240 that: a) the user has entered the required “what you know” parameter, and that b) the user is initiating the online transaction on a platform trusted by the relying party. The cryptogram, unique due to a specific seed provisioned by an assigned issuer, provides a qualified, “what you have” factor.

By way of example, the architecture may be used to implement a dynamic card-verification value (CVV) for credit card issuers. Users may implement the methods above to obtain a dynamic cryptogram (i.e., a one-time-password), which may be coupled with a registered credit card account and sent to the card issuer for validation. Once validated the card issuer returns a dynamic card-verification-value (CVV) as a substitute for the static CVV printed on the back of a credit card. This CVV is compatible with existing eCommerce checkout pages, and is validated by the payment ecosystem as being legitimate, and derived from a pre-authenticated transaction. One skilled in the art will recognize that information other than the CVV could be returned by the card issuer as long as the transaction can still be processed by the payment ecosystem. A dynamic CVV lowers the risk rating of the transaction since the probability of fraud for a transaction has been reduced.

Thus, the architecture described herein securely integrates the processes of credential storage, solicitation and authentication within a trusted execution environment that can be adapted to serve various credential acquisition requirements. Rules serve to govern token access so that authentication methods can vary provided the required authentication level of a given credential can be met. For example, assume that for release of a stored credit card credential the issuer access rules state that either a user-entered PIN or matching biometric pattern must be entered. Assuming that both types of authentication methods/sensors are available on the platform, entry of either qualifying authentication credential will result in release of the requested financial credential according to the general algorithm illustrated in FIG. 4.

For a given credential acquirer or relying party, rules can also state that cryptographic operations must be applied to a credential prior to it being released from the trusted execution environment. This provides additional levels of security in that even when released to the relatively hostile O/S environment, that it is still protected from data-in-motion compromise.

The architecture also provides an open issuer environment capable of integrating a wide variety of credentials issued from a wide variety of entities. Thus, many issuers can participate and issue credentials into the system. This open issuer feature is represented by the Issuer 230 element of FIG. 3.

The terms “logic instructions” as referred to herein relates to expressions which may be understood by one or more machines for performing one or more logical operations. For example, logic instructions may comprise instructions which are interpretable by a processor compiler for executing one or more operations on one or more data objects. However, this is merely an example of machine-readable instructions and embodiments are not limited in this respect.

The terms “computer readable medium” as referred to herein relates to media capable of maintaining expressions which are perceivable by one or more machines For example, a computer readable medium may comprise one or more storage devices for storing computer readable instructions or data. Such storage devices may comprise storage media such as, for example, optical, magnetic or semiconductor storage media. However, this is merely an example of a computer readable medium and embodiments are not limited in this respect.

The term “logic” as referred to herein relates to structure for performing one or more logical operations. For example, logic may comprise circuitry which provides one or more output signals based upon one or more input signals. Such circuitry may comprise a finite state machine which receives a digital input and provides a digital output, or circuitry which provides one or more analog output signals in response to one or more analog input signals. Such circuitry may be provided in an application specific integrated circuit (ASIC) or field programmable gate array (FPGA). Also, logic may comprise machine-readable instructions stored in a memory in combination with processing circuitry to execute such machine-readable instructions. However, these are merely examples of structures which may provide logic and embodiments are not limited in this respect.

Some of the methods described herein may be embodied as logic instructions on a computer-readable medium. When executed on a processor, the logic instructions cause a processor to be programmed as a special-purpose machine that implements the described methods. The processor, when configured by the logic instructions to execute the methods described herein, constitutes structure for performing the described methods. Alternatively, the methods described herein may be reduced to logic on, e.g., a field programmable gate array (FPGA), an application specific integrated circuit (ASIC) or the like.

In the description and claims, the terms coupled and connected, along with their derivatives, may be used. In particular embodiments, connected may be used to indicate that two or more elements are in direct physical or electrical contact with each other. Coupled may mean that two or more elements are in direct physical or electrical contact. However, coupled may also mean that two or more elements may not be in direct contact with each other, but yet may still cooperate or interact with each other.

Reference in the specification to “one embodiment” or “some embodiments” means that a particular feature, structure, or characteristic described in connection with the embodiment is included in at least an implementation. The appearances of the phrase “in one embodiment” in various places in the specification may or may not be all referring to the same embodiment.

Although embodiments have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. A controller comprising logic to:
receive a request for a credential to authenticate a user for a transaction;
in response to a determination that a credential which satisfies the request resides on a memory module, execute an authentication routine to authenticate a user of the controller;
in response to a successful authentication, retrieve the credential from the memory module; and
provide a token to certify the credential in response to the request.

2. The controller of claim 1, wherein the logic comprises a token access manager module to dynamically assign one or more trusted algorithms and rules, from which one or more context-specific forms of user authentication may be determined.

3. The controller of claim 1, further comprising logic to apply at least one post-processing operation to the credential.

4. The controller of claim 1, further comprising an input/output (I/O) module to provide I/O access to the controller.

5. The controller of claim 1, wherein the credential comprises at least one of an input on a secured keyboard input path, a GPS location, a biometric parameter, an accelerometer/gyroscope, or a malware-interception-resistant graphical pass code input mechanism.

6. The controller of claim 1, wherein the memory module is to comprise a credential repository to store and access credentials.

7. The controller of claim 1, wherein the authentication routine is to use multi-factor authentication of a user.

8. An electronic device, comprising:
an operating system executing on a processor and which implements an untrusted computing environment; and
a controller, comprising:
a memory module;
logic to:
receive a request for a credential to authenticate a user for a transaction;
in response to a determination that a credential which satisfies the request resides on a memory module coupled to the controller, execute an authentication routine to authenticate a user of the controller;
in response to a successful authentication, retrieve the credential from the memory module; and
provide a token to certify the credential in response to the request.

9. The electronic device of claim 8, wherein the logic comprises a token access manager module to dynamically assign one or more trusted algorithms and rules, from which one or more context-specific forms of user authentication may be determined.

10. The electronic device of claim 8, further comprising logic to apply at least one post-processing operation to the credential.

11. The electronic device of claim 8, further comprising an input/output (I/O) module to provide I/O access to the controller.

12. The electronic device of claim 8, wherein the credential comprises at least one of an input on a secured keyboard input path, a GPS location, a biometric parameter, an accelerometer/gyroscope, or a malware-interception-resistant graphical pass code input mechanism.

13. The electronic device of claim 8, wherein the memory module comprises a credential repository to store and access credentials.

14. The electronic device of claim 8, wherein the authentication routine requires multi-factor authentication of a user.

15. A computer program product comprising logic instructions stored on a tangible computer readable medium which, when executed by a controller, configure the controller to perform a method, comprising:
receiving, in a controller, a request for a credential to authenticate a user for a transaction; and
in response to a determination that a credential which satisfies the request resides on a memory module, executing an authentication routine to authenticate a user of the controller;
in response to a successful authentication, retrieving the credential from the memory module; and
providing a token to certify the credential in response to the request.

16. The computer program product of claim 15, further comprising logic instructions stored on a tangible computer readable medium which, when executed by a controller, configure the controller to perform a method, comprising assigning a one-time password to a user.

17. The computer program product of claim 15, further comprising logic instructions stored on a tangible computer readable medium which, when executed by a controller, configure the controller to perform a method, comprising assigning a digital signature to the token using a private key acquired through a credential store.

18. The computer program product of claim 15, further comprising logic instructions stored on a tangible computer readable medium which, when executed by a controller, configure the controller to perform a method, comprising applying at least one post-processing operation to the credential.

19. The computer program product of claim 15, wherein the credential comprises at least one of a secured keyboard input path, a GPS location, a biometric parameter, an accelerometer/gyroscope or a malware interception resistant graphical pass code input mechanism.

20. The computer program product of claim 15, wherein the memory module comprises a credential repository to store and provide access to credentials.

21. The computer program product of claim 15, wherein the authentication routine requires multi-factor authentication of a user.
